(19) United States
(12) Patent Application Publication
(10) Pub. No.: US 2009/0165579 A1
(43) Pub. Date: Jul. 2, 2009

(54) METHOD AND A DEVICE FOR TRANSMITTING ROTARY MOTION

(75) Inventor: Martin Johansson, Ludvika (SE)

Correspondence Address: VENABLE LLP, P.O. BOX 34385, WASHINGTON, DC, 20043-9998, US

(73) Assignee: ABB TECHNOLOGY LTD., ZURICH (CH)

(21) Appl. No.: 12/295,185

(22) PCT Filed: Mar. 27, 2007
(86) PCT No.: PCT/SE07/50187

§ 371 Date: Sep. 29, 2008

(30) Foreign Application Priority Data
Mar. 28, 2006 (SE) 0600691-0

(51) Int. Cl. F16H 25/08; H01H 19/00

(52) U.S. Cl. 74/55; 200/336

(57) ABSTRACT

A device for transmitting rotary motion. The device includes a motion-transmitting member for transforming an alternating rotary motion of a input drive shaft into a unidirected rotary motion of a driven body driven about a drive shaft. The motion-transmitting member includes an intermediate body rotatable about an axis of rotation. A mechanical energy accumulation member is mechanically connected to the driven body. The intermediate body includes a cam disk in the form of a driving pulley and the mechanical energy accumulation member includes a tensile/compressive spring unit.

### FIELD OF THE INVENTION

The present invention relates to a device for transmitting rotary motion, said device for transmitting rotary motion comprising a motion-transmitting member for transforming a driving body rotatable about an axis of rotation into rotary motion of a body driven about an axis of rotation.

The invention further relates to a use of the invented device, in which the driven body is adapted to operate contacts of a diverter switch or an on-load tap changer in a transformer.

Further, the invention relates to a method of driving a body.

### BACKGROUND ART

In certain applications, there is a need to achieve a short, powerful rotary motion in a definite direction. In certain cases, this can be quite unproblematic if the available drive source has a corresponding movement characteristic. However, this is not always the case. It may occur that the available drive source is of such a kind that it carries out rotary motion in one direction as well as in the other direction.

There are also situations where the drive source included does not immediately achieve a required powerful torque for the necessary short period. It may also occur that both of these imperfections occur simultaneously as far as the available drive source is concerned.

One example of such a situation is when operating a diverter switch in an on-load tap changer for controlling the voltage of a transformer. In this case, it may be advantageous that the operating movement always occurs in the same direction of rotation, and it should occur for a relatively short period of time. Usually, the drive source for such a diverter switch is in the form of the drive shaft that operates the selector switch, that is, the mechanism that sets the connections to new tap points in the winding of the trans-former when a change of voltage is to take place. The drive shaft of the selector switch rotates in different directions in dependence on whether it is a question of increasing or reducing the voltage of the transformer.

From WO 89/08924, a motion-transmitting mechanism is previously known, which is able to transform a rotary motion in one or the other direction into a unidirectional movement while at the same time concentrating the rotary motion with respect to time. The unidirection of the movement takes place by a special design of the spring, and elements directly cooperating therewith, which accumulate the energy and concentrate the rotary motion.

From WO 2006/004527, a motion-transmitting mechanism is previously known, which transforms a rotary motion in one or the other direction into a unidirectional movement which via, inter alia, a gear-wheel mechanism and shafts, transfers the rotary motion into an energy-storing system in the form of a spring unit. When the spring unit with a locking device is released, motion is transferred to a final shaft. Both the selector and the diverter switch are surrounded by transformer oil.

SE 0501712-5 describes a motion-transmitting mechanism that transforms an alternating rotary motion into a unidirected rotary motion via a linear translatory motion. Also in this motion-transmitting mechanism, the rotary motion is transmitted to an energy-storing system in the form of a spring unit.

According to a first aspect of the present invention, is seeks to provide an improved device for transmitting a rotary motion as well as a mechanical energy-storing system connected thereto.

According to a second aspect the invention seeks to provide a improved use for transmission of a rotary motion.

According to a third aspect, the invention seeks to provide an improved method for transmitting a rotary motion.

### SUMMARY OF THE INVENTION

According to the first aspect of the invention, there is provided a device as specified in claim 1. Embodiments will be clear from the subsequent subclaims 2-10.

According to the second aspect of invention, a use of the device is there is provided according to claim 11.

The invention is also directed to a method by which the described device operates and including method steps for carrying out every function of the device according to the third aspect of the invention as specified in claim 12 and the associated subclaims 13-16.

### BRIEF DESCRIPTION OF THE DRAWINGS

Embodiments of the invention will be explained, by way of example only, in greater detail by the following detailed description of advantageous embodiments thereof with reference to the accompanying drawing figures.

FIG. 1 is a block diagram that schematically illustrates the transmission of the rotary motion according to an embodiment of the invention.

FIGS. 2a-2d schematically illustrate the mode of operation of the energy accumulation member and the intermediate body connected thereto.

FIG. 3 illustrates in detail an embodiment of the energy accumulation member and the intermediate body.

### DESCRIPTION OF THE PREFERRED EMBODIMENTS

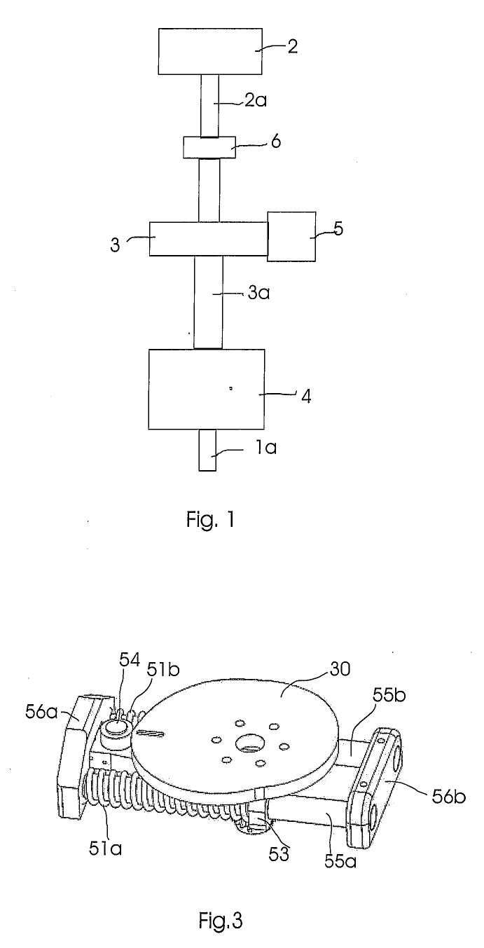

FIG. 1 is a block diagram that schematically illustrates the mechanical coupling of the operating members that brings about the movement of the components of a diverter switch or a tap changer.

An input drive shaft 1a is connected to a axis of rotation 3a via a motion-transforming member 4. The input drive shaft 1a is of such a nature that, when operated, it may rotate in one or the other direction. The motion-transforming member 4 is designed such that a rotary motion is always imparted to the axis of rotation 3a in one and the same direction irrespective of in which direction the input drive shaft 1a is rotated. The drive source for the input drive shaft 1a is the drive shaft that operates a diverter selector switch (not shown) in a transformer, that is, the mechanism that sets the connections to new tap points in the winding of a transformer when a change of voltage is to take place. The input drive shaft 1a of the diverter selector switch rotates in different directions in dependence on whether it is a question of increasing or reducing the voltage of the transformer. The output axis of rotation 3a is connected to an intermediate body 3 and to an associated energy accumulation member 5 as well as a driven body 2 with a drive shaft 2a. The body 2, in its turn, drives contacts (not shown here) of the diverter switch. These may be of a kind described in greater detail in WO 2006/004527.

The motion-transforming member 4 may, for example, be either of the kind described in the patent application WO 2006/004527 or of the kind described in the patent application WO 2006/050552.

When the axis of rotation 3a is rotated, it feeds energy into the mechanical energy accumulation member 5 via an intermediate body 3. After a definite angular motion of the axis of rotation, the accumulated energy is released to the intermediate body which rotates the drive shaft 2a rapidly and powerfully and thus imparts a rotary motion to the driving body 2, said rotary motion influencing the components of the diverter switch which are described in detail in the above-mentioned WO 2006/004527. A gear change (not shown) may be arranged between the motion-transforming member 4 and the axis of rotation 3a, so that the movement of the 3a is preferably four times as large as the movement of the motion-transforming member.

A freewheel 6 is arranged on the drive shaft 2a, the function of said freewheel being to allow rotation of the intermediate body in one direction but to block rotation in the other direction, thus ensuring that the driving motion is not reversed. The freewheel may be of any conventional kind, that is, be in the form of a ratchet gearing that transmits torque in one direction but freewheels in the other direction.

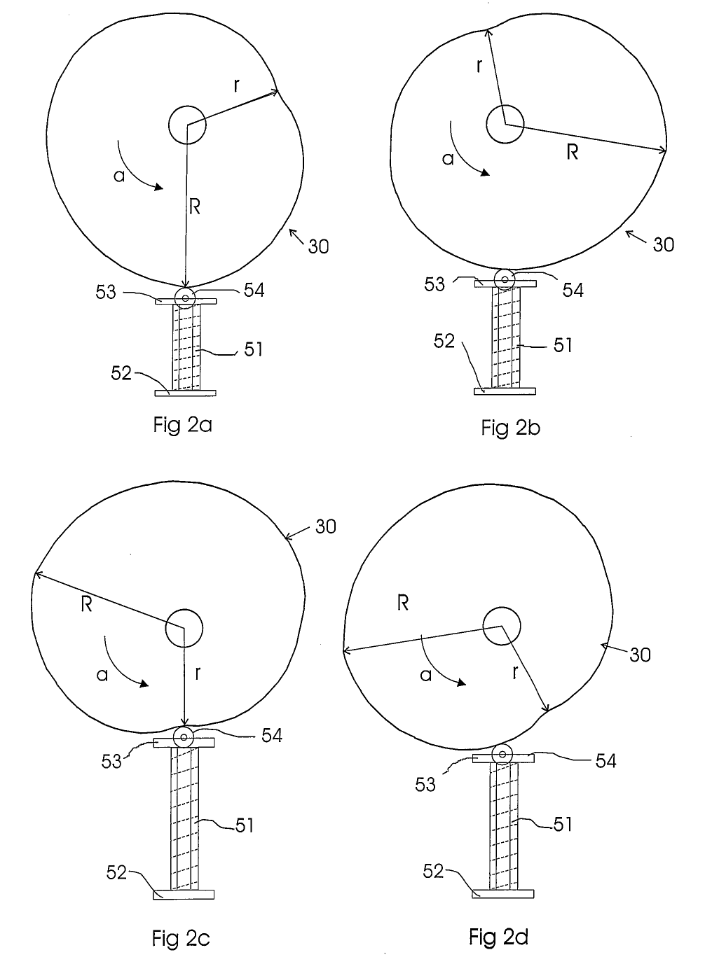

According to an embodiment of the invention, the intermediate body 3 comprises a cam-shaped driving pulley 30 and the mechanical energy accumulation member 5 is designed as a tensile/compressive spring unit 51, which will be described in greater detail with reference to FIGS. 2a-2d and FIG. 3.

FIGS. 2a to 2d show schematically the mode of operation of the tensile/compressive spring unit 51 in cooperation with the driving pulley 30. The driving pulley is designed with a largest diameter R and a smallest diameter r. The tensile/-compressive spring unit 51 is connected at one end to a fixed yoke 52 and a movable yoke 53. The movable yoke 53 is provided with a rolling device 54 making contact with the periphery of the driving pulley 30. The movable yoke 53 is adapted to run in a radial direction and parallel to the plane of the driving pulley. This will cause the spring forces to be directed perpendicular to the axis of rotation of the driving pulley, which thus substantially absorbs radially directed forces. The movable yoke 53 moves with a length of stroke corresponding to R-r while the driving pulley rotates one turn about its axis. The direction of rotation of the driving pulley is shown by the arrow a.

In FIG. 2a, the driving pulley is in a position where the rolling device 54 with the movable yoke makes contact with the periphery of the driving pulley where the driving pulley exhibits its largest radius R. In this position, the spring unit 51 is charged with maximum mechanical energy. This constitutes the starting position for a driving motion of the driving body 2.

FIG. 2b shows a position where the mechanical energy stored in the spring unit imparts an accelerating motion to the driving pulley via the drive roll 54. From the starting position at radius R, the driving pulley has here been driven approximately 90°.

FIG. 2c shows the position for the driving pulley when the drive roll reaches the smallest radius r of the driving pulley. In this position, the intended part of the mechanical energy stored in the spring unit has been transmitted to the driving pulley. In this position, the driving pulley has moved approximately two-thirds of a turn, or 2400 from the position 2a. In this position, the spring unit also has a certain prestress, thus ensuring the abutment of the drive roll against the driving pulley.

When the driving pulley has passed the position according to FIG. 2c, no more energy can be transmitted from the spring unit. Since the radius of the driving pulley is increasing, this implies that the roll with the movable yoke during after the position of FIG. 2c compresses the spring unit which thus receives mechanical energy. This energy is taken from the mechanical motion torque of the driving pulley and parts mechanically connected thereto. This entails a braking of the driving pulley.

FIG. 2d shows a position where the driving pulley has delivered its kinetic energy to the spring unit and has been braked to a stop position where the speed of the driving pulley is zero. Because of the engagement of the freewheel, the driving pulley cannot change its direction of rotation either.

In this position, the driving pulley assumes a wait state before the next operation. This is initiated when the input shaft 1a, via the motion-transforming member 4 and the axis of rotation 3a, gives the driving pulley a driving motion. While the driving pulley is rotated to its initial position in FIG. 2a, the spring unit is again charged with full mechanical energy, whereby a full turn has been completed.

When the driving pulley has reached the position according to FIG. 2a, where the driving pulley makes contact with the drive roll with its largest diameter R, the new driving motion is spontaneously initiated by the driven body 2. Thus no separate release member is needed to initiate the driving motion of the driving pulley.

It is realized that it is possible, within the scope of the invention, to influence the different processes above, namely, the driving of the driving pulley from the spring unit, the braking of the driving pulley by the transmission of kinetic energy from the driving pulley to the spring unit, and the tensioning of the spring unit to its initial position, by appropriately dimensioning the cam shape. By adapting the shape of the driving pulley, it is thus realized that it is possible to influence both the acceleration and deceleration processes of the driving pulley.

Preferably, the shape of the driving pulley is of such a nature that it is adapted to the load and hence imparts to the driven body 2 a uniform speed after a short acceleration process.

Also, no separate braking devices for the driving pulley need be arranged, since its remaining kinetic energy is automatically returned to the spring unit and the energy balance implies that the driving pulley, due to any friction losses, independently of the original storing of mechanical energy by the spring unit, always rotates less than one turn. This entails considerable advantages, especially when testing and adjusting the drive system, since the process will be automatically controllable also in the event that, for example, the driving body 2 is disengaged from a subsequent diverter switch. Also in a test position, where the driving body is disengaged from the driving pulley, it will exhibit a controlled motion pattern.

When the driving pulley moves between the positions shown in FIGS. 2a and 2c, the spring 51 gives off energy, and when the driving pulley moves between the positions shown in FIGS. 2c and 2d, the spring 51 stores energy.

FIG. 3 shows an alternative embodiment of the spring unit. Two guides 55a and 55b, respectively, which are arranged in parallel, are secured at their ends to attachments 56a and 56b. Two springs 51a and 51b are each arranged to run along a respective guide. The springs are secured to the attachment 56a, which thus serves as a fixed yoke. The other end of the respective spring is secured to a common movable yoke 53, which in turn is arranged to run parallel to the guides. A roll 54 is connected to the yoke 53 and makes contact with the driving pulley 30. In this case, the spring unit is charged with mechanical energy when the springs are tensioned to maximum position, which occurs when the roll 54 contacts the driving pulley at its largest diameter R.

According to one embodiment, the largest radius of the driving pulley is between 80 mm and 120 mm, preferably 105 mm, and its smallest radius is between 50 mm and 80 mm, preferably 60 mm. The difference between the largest radius R and the smallest radius r may be between 30 mm and 60 mm, preferably 45 mm.

According to one embodiment, the force of the rolling device against the driving pulley is between 1000 N and 1500 N, and the speed of rotation of the driving pulley is adapted to vary from 0 to 25 rad/s. The time from start to stop of the driving pulley may in this case be 0.2 s.

In the figures the rolling device is designed as a ball-bearing roller, which gives low friction and a large contact surface against the periphery of the driving pulley. According to one embodiment, the roller is a needle bearing. Alternatively, the rolling device may be designed as a spherical ball, rotatably arranged in a ball cage. To minimize the surface pressure against the periphery of the driving pulley, it is suitable in this case to give its cross section a corresponding circular cross-section shape.

The device is suitably surrounded by transformer oil, which serves both as lubrication and cooling of the mechanical components included in the device.

The method of transmitting the driving motion may be summarized in the following operating steps:
a) the rolling device 54 imparts to the driving pulley 30 a rotary motion while the rolling device is running from the largest radius R of the driving pulley to its smallest radius r while transmitting the rotary motion to the drive shaft 2a and the driven body 2,
b) the rotary motion of the driving pulley 30 is braked to 0 while the kinetic energy of the driving pulley is transmitted to the tensile/compressing spring unit 51,
c) the driving pulley 30 is maintained stationary with the aid of a freewheel 6, which by means of a ratchet gearing prevents the driving pulley from changing its direction of rotation,
d) the input shaft 1a imparts to the driving pulley 30 a rotary motion via the axis of rotation 3a, while the rolling device is running from the stationary position of the driving pulley till the largest radius R of the driving pulley reaches the rolling device, whereby the operating step a) starts instantaneously.

The scope of the invention must not be limited by the embodiments presented but also contain embodiments obvious to a person skilled in the art. For instance the device can be immersed in dielectric fluid with similar properties as transformer oil.

1. A device for transmitting rotary motion to a body driven about an drive shaft via a motion-transmitting member, the device comprising:
an intermediate body connected to and rotatable about an axis of rotation, the intermediate body comprising a cam-shaped driving pulley;
a mechanical energy accumulation member comprising a spring device adapted to receive energy from the axis of rotation, and the energy accumulation member interacting with the cam-shaped driving pulley; and
a module configured to transmit mechanical energy accumulated in the spring device to the driven body via the drive shaft.

2. The device according to claim 1, wherein the spring device of the energy accumulating member comprises a tensile/compressive spring unit connected to a fixed yoke and a movable yoke, the movable yoke comprises a rolling device making contact with the periphery of the driving pulley.

3. The device according to claim 2, wherein
the movable yoke is adapted to run in a radial direction and parallel to a plane of the driving pulley with a length of stroke corresponding to R-r,
the tensile/compressive spring unit is adapted to receive energy from the driving pulley during movement of the movable yoke from a position at a smallest radius r to a largest radius R,
the tensile/compressive spring unit is adapted to give off energy to the driving pulley during the movement of the movable yoke from the position at the largest radius R to the smallest radius r.

4. The A device according to claim 1, further comprising:
a freewheel adapted to allow the driving pulley to rotate in one direction.

5. The device according to claim the axis of rotation is adapted to be driven by an alternating rotary motion of an input drive shaft, the device further comprising:
a motion-transforming member for transforming the alternating rotary motion of the drive shaft into a unidirected rotary motion of the axis of rotation.

6. The device according to claim 1, wherein the driving pulley exhibits an angle between a largest radius and a smallest radius of the driving pulley of between 220° and 270°.

7. The device according to claim 2, wherein the rolling device is adapted to make contact with the driving pulley with a spring force of between 1000 N and 1500 N.

8. The device according to claim 1, wherein the intermediate body and the energy accumulation member comprise an integrated part.

9. The device according to claim 5, wherein the input drive shaft and the drive shaft are parallel.

10. The device according to claim 1, wherein the driven body is mechanically connected to operating means for contacts of an on-load tap changer in a transformer or a reactor.

11. A method for transmission of rotary motion from a driving body to a driven body, the method comprising:
providing a device for transmitting rotary motion to a body driven about an drive shaft via a motion-transmitting member, the device comprising an intermediate body connected to and rotatable about an axis of rotation, the intermediate body comprising a cam-shaped driving pulley; a mechanical energy accumulation member comprising a spring device adapted to receive energy from the axis of rotation and the energy accumulation member interacting with the cam-shaped driving pulley; and a module configured to transmit mechanical energy accumulated in the spring device to the driven body via the drive shaft; and
adapting the driven body to operate contacts of an on-load tap changer in a transformer or reactor.

12. A method of transmitting a rotary motion to a body driven by a drive shaft from an intermediate body connected to and rotatable about an axis of rotation, the method comprising:
transmitting mechanical energy from the axis of rotation to a mechanical energy accumulation member in the form of a spring device;
transmitting accumulated mechanical energy in the spring device to the drive shaft;
wherein the mechanical energy is transmitted to and from the energy accumulation member via the intermediate body, the energy accumulation member comprising a rotating cam-shaped driving pulley that drives, or is driven by, a rolling device that is mechanically connected to a movable end of a spring device designed as a tensile/-compressive spring unit.

13. The method of transmitting a driving motion according to claim 12, further comprising:
imparting a rotary motion to driving pulley with the rolling device while the rolling device is running from a largest radius of the driving pulley to a smallest radius of the driving pulley while transmitting the rotary motion to the drive shaft and the driven body,
braking the rotary motion of the driving pulley to 0 while a kinetic energy of the driving pulley is transmitted to the tensile/compressing spring unit,
maintaining the driving pulley stationary with the aid of a freewheel comprising a ratchet gearing configured to prevent the driving pulley from changing a direction of rotation, and
imparting a rotary motion to the driving pulley with the axis of rotation while the rolling device is running from the stationary position of the driving pulley to the largest radius of the driving pulley reaches the rolling device, whereby the operating step a) starts instantaneously.

14. The method of transmitting a driving motion according to claim 12, wherein the axis of rotation is driven by an input drive shaft via a motion-transmitting member and transforms an alternating rotary motion of the input drive shaft into a unidirected rotary motion.

15. The method of transmitting a driving motion according to claim 13, wherein imparting a rotary motion to driving pulley with the rolling device and the braking the rotary motion of the driving pulley occur within a time interval of a length of about 0.2 s.

16. The method of transmitting a driving motion according to claim 12, wherein the driven body operates the contacts of an on-load tap changer in a transformer or a reactor.
